(19) United States
(12) Patent Application Publication
(10) Pub. No.: US 2026/0038094 A1
(43) Pub. Date: Feb. 5, 2026

(54) FAST LOW-LIGHT IMAGE VISIBILITY ENHANCEMENT

(71) Applicant: Samsung Electronics Co., Ltd., Suwon-si (KR)

(72) Inventors: Yingen Xiong, Mountain View, CA (US); Christopher A. Peri, Mountain View, CA (US)

(21) Appl. No.: 19/173,632

(22) Filed: Apr. 8, 2025

Related U.S. Application Data
(60) Provisional application No. 63/677,064, filed on Jul. 30, 2024.

(51) Int. Cl. G06T 5/60; G06T 5/70; G06T 7/00

(52) U.S. Cl. CPC G06T 5/60; G06T 5/70; G06T 7/0002; G06T 2207/20081

(57) ABSTRACT

A method includes obtaining, using at least one imaging sensor of an electronic device, a first image frame of a scene. The method also includes determining, using at least one processing device of the electronic device, a low-light image score indicative of a brightness of the first image frame. The method further includes, in response to the low-light image score indicating that the brightness of the first image frame is below a threshold, applying, using the at least one processing device, a low-light visibility enhancement model to the first image frame in order to generate a second image frame having a higher brightness than the first image frame. The low-light visibility enhancement model is trained using at least one dataset that includes image frames obtained using the at least one imaging sensor of the electronic device.

### CROSS-REFERENCE TO RELATED APPLICATION AND PRIORITY CLAIM

This application claims priority under 35 U.S.C. § 119(e) to U.S. Provisional Patent Application No. 63/677,064 filed on Jul. 30, 2024. This provisional patent application is hereby incorporated by reference in its entirety.

### TECHNICAL FIELD

This disclosure relates generally to image processing systems and processes. More specifically, this disclosure relates to fast low-light image visibility enhancement.

### BACKGROUND

Extended reality (XR) systems are becoming more and more popular over time, and numerous applications have been and are being developed for XR systems. Some XR systems (such as augmented reality or “AR” systems and mixed reality or “MR” systems) can enhance a user's view of his or her current environment by overlaying digital content (such as information or virtual objects) over the user's view of the current environment. For example, some XR systems can often seamlessly blend virtual objects generated by computer graphics with real-world scenes.

### SUMMARY

This disclosure relates to fast low-light image visibility enhancement.

In a first embodiment, a method includes obtaining, using at least one imaging sensor of an electronic device, a first image frame of a scene. The method also includes determining, using at least one processing device of the electronic device, a low-light image score indicative of a brightness of the first image frame. The method further includes, in response to the low-light image score indicating that the brightness of the first image frame is below a threshold, applying, using the at least one processing device, a low-light visibility enhancement model to the first image frame in order to generate a second image frame having a higher brightness than the first image frame. The low-light visibility enhancement model is trained using at least one dataset that includes image frames obtained using the at least one imaging sensor of the electronic device. A non-transitory machine-readable medium may include instructions that when executed cause at least one processor to perform the method of the first embodiment.

In a second embodiment, an apparatus includes at least one imaging sensor and at least one processing device. The at least one processing device is configured to obtain a first image frame of a scene captured using the at least one imaging sensor. The at least one processing device is also configured to determine a low-light image score indicative of a brightness of the first image frame. The at least one processing device is further configured, in response to the low-light image score indicating that the brightness of the first image frame is below a threshold, to apply a low-light visibility enhancement model to the first image frame in order to generate a second image frame having a higher brightness than the first image frame. The low-light visibility enhancement model is trained using at least one dataset that includes image frames obtained using the at least one imaging sensor.

Any one or any combination of the following features may be used with the first or second embodiment. The low-light visibility enhancement model may represent a specified one of multiple low-light visibility enhancement models, and the specified low-light visibility enhancement model may be selected from among the multiple low-light visibility enhancement models based on the brightness of the first image frame. In response to the low-light image score indicating that the brightness of the first image frame is above the threshold, the low-light visibility enhancement model may not be applied to the first image frame. The low-light visibility enhancement model can be trained using the at least one dataset. Training the low-light visibility enhancement model may include, for each of the at least one imaging sensor, identifying parameters of a response model and a brightness transform model based on at least part of the at least one dataset, generating an exposure ratio map for adjusting image contrast and visibility, integrating the brightness transform model and the exposure ratio map to generate an integrated brightness transform model, and combining the integrated brightness transform model and the response model. The low-light image score may include a signal-to-noise ratio (SNR) and an image brightness value associated with the first image frame. The low-light image score may be based on image data in a portion of the first image frame, and the portion of the first image frame may represent an area in the scene on which a user's eyes are gazing or focused. Prior to application of the low-light visibility enhancement model, the first image frame may be converted from a first image format that lacks luminance data to a second image format that includes luminance data. After application of the low-light visibility enhancement model to at least some of the luminance data, the second image frame may be converted from the second image format to the first image format or a third image format. At least one transformation may be applied to the second image frame in order to generate a transformed image frame, the transformed image frame may be rendered for display.

In a third embodiment, a method includes obtaining, using at least one imaging sensor of an electronic device, image frames having different exposures. The method also includes generating, using at least one processing device of the electronic device, at least one training dataset using the image frames. The method further includes training at least one low-light visibility enhancement model using the at least one dataset, where each low-light visibility enhancement model is trained to increase brightness in captured image frames. Training the at least one low-light visibility enhancement model includes, for each of the at least one imaging sensor, identifying parameters of a response model and a brightness transform model based on at least part of the at least one dataset and generating an exposure ratio map for adjusting image contrast and visibility, where the low-light visibility enhancement model is based on the response model, the brightness transform model, and the exposure ratio map. An apparatus may include at least one processing device configured to perform the method of the third embodiment. A non-transitory machine-readable medium may include instructions that when executed cause at least one processor to perform the method of the third embodiment.

Any one or any combination of the following features may be used with the third embodiment. The at least one imaging sensor may represent multiple imaging sensors, multiple exposure ratio maps may be generated, and each exposure ratio map may be for adjusting image contrast and visibility of image frames captured using an associated one of the imaging sensors. For each of the at least one imaging sensor, the parameters of the response model may be based on one or more properties of the imaging sensor, and the parameters of the brightness transform model may be based on the one or more properties of the imaging sensor and one or more exposure properties of the image frames captured using the imaging sensor. For each of the at least one imaging sensor, the exposure ratio map may be integrated with the brightness transform model to generate an integrated brightness transform model, and the integrated brightness transform model and the response model may be combined to generate the low-light visibility enhancement model for the imaging sensor. The image frames may be converted from a first image format that lacks luminance data to a second image format that includes luminance data. For each of the at least one imaging sensor, the parameters of at least one of the response model or the brightness transform model may be identified using the luminance data of the image frames captured using the imaging sensor.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another clement (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include any other electronic devices now known or later developed.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which:

FIG. 1 illustrates an example network configuration including an electronic device in accordance with this disclosure;

FIG. 2 illustrates an example process for fast low-light image visibility enhancement for video see-through (VST) extended reality (XR) or other applications in accordance with this disclosure;

FIGS. 3A and 3B illustrate an example architecture for fast low-light image visibility enhancement for VST XR or other applications in accordance with this disclosure;

FIG. 4 illustrates an example technique for creating a low-light visibility enhancement model in accordance with this disclosure;

FIG. 5 illustrates an example technique for applying adaptive low-light visibility enhancement in accordance with this disclosure;

FIG. 6 illustrates an example technique for performing adaptive low-light image frame detection in accordance with this disclosure;

FIG. 7 illustrates an example method for fast low-light image visibility enhancement for VST XR or other applications in accordance with this disclosure; and

FIG. 8 illustrates an example method for training a low-light visibility enhancement model in accordance with this disclosure.

### DETAILED DESCRIPTION

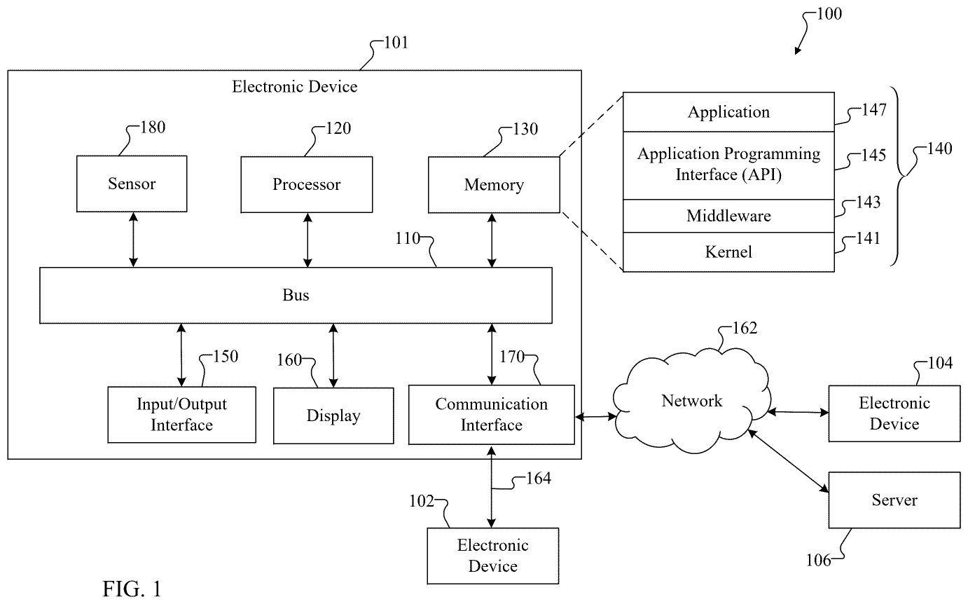

FIGS. 1 through 8, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, extended reality (XR) systems are becoming more and more popular over time, and numerous applications have been and are being developed for XR systems. Some XR systems (such as augmented reality or “AR” systems and mixed reality or “MR” systems) can enhance a user's view of his or her current environment by overlaying digital content (such as information or virtual objects) over the user's view of the current environment. For example, some XR systems can often seamlessly blend virtual objects generated by computer graphics with real-world scenes.

Optical see-through (OST) XR systems refer to XR systems in which users directly view real-world scenes through head-mounted devices (HMDs). Unfortunately, OST XR systems face many challenges that can limit their adoption. Some of these challenges include limited fields of view, limited usage spaces (such as indoor-only usage), failure to display fully-opaque black objects, and usage of complicated optical pipelines that may require projectors, waveguides, and other optical elements. In contrast to OST XR systems, video see-through (VST) XR systems (also called “passthrough” XR systems) present users with generated video sequences of real-world scenes. VST XR systems can be built using virtual reality (VR) technologies and can have various advantages over OST XR systems. For example, VST XR systems can provide wider fields of view and can provide improved contextual augmented reality.

A VST XR device often includes one or more imaging sensors (also called “see-through cameras”) that capture high-resolution image frames of a user's surrounding environment. These image frames are processed in an image processing pipeline in order to generate final rendered views of the user's surrounding environment. Unfortunately, VST XR devices can suffer from various problems. One problem is that the image quality of the captured image frames can be affected by conditions in the surrounding environment and properties of the imaging sensors themselves. For example, when inadequate lighting is available in the user's surrounding environment, captured image frames can appear dark and noisy, which makes it difficult for the user to discern content in the captured environment and can even cause user discomfort.

This disclosure provides various techniques supporting fast low-light image visibility enhancement for VST XR or other applications. As described in more detail below, a first image frame of a scene can be obtained using at least one imaging sensor of an electronic device. A low-light image score indicative of a brightness of the first image frame can be determined. In response to the low-light image score indicating that the brightness of the first image frame is below a threshold, a low-light visibility enhancement model can be applied to the first image frame in order to generate a second image frame having a higher brightness than the first image frame. The low-light visibility enhancement model can be trained using at least one dataset that includes image frames obtained using the at least one imaging sensor of the electronic device.

Moreover, as described in more detail below, image frames having different exposures can be obtained using at least one imaging sensor of an electronic device, and at least one training dataset can be generated using the image frames. A low-light visibility enhancement model can be trained using the at least one dataset, where the low-light visibility enhancement model can be trained to increase brightness in captured image frames. Training the low-light visibility enhancement model can include, for each of the at least one imaging sensor, identifying parameters of a response model and a brightness transform model based on at least part of the at least one dataset and generating an exposure ratio map for adjusting image contrast and visibility (where the exposure ratio map can be based on the response model and the brightness transform model).

In this way, the disclosed techniques can be used to provide visual enhancement of image frames, including image frames captured indoors or outdoors in low-light environments. For example, the disclosed techniques can enable improved images to be rendered and displayed to users, even when those images are based on image frames that are noisy and captured in low-light conditions. As a result, this can significantly improve user experience, even in low-light environments. Moreover, these techniques can be used to improve low-light image quality, remove low-light noise, and enhance image visibility, which can lead to the generation of normal-quality image frames captured in low-light environments. This type of functionality may find use in various applications, such as low-light image visibility enhancement for VST XR devices or other devices, low-light noise reduction for VST XR devices or other devices, and low-light image quality enhancement for VST XR devices or other devices.

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, and a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described below, the processor 120 may perform one or more functions related to fast low-light image visibility enhancement for VST XR or other applications.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications that, among other things, perform fast low-light image visibility enhancement for VST XR or other applications. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, the sensor(s) 180 can include cameras or other imaging sensors, which may be used to capture image frames of scenes. The sensor(s) 180 can also include one or more buttons for touch input, one or more microphones, a depth sensor, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. Moreover, the sensor(s) 180 can include one or more position sensors, such as an inertial measurement unit that can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the electronic device 101 can be a wearable device or an electronic device-mountable wearable device (such as an HMD). For example, the electronic device 101 may represent an XR wearable device, such as a headset or smart eyeglasses. In other embodiments, the first external electronic device 102 or the second external electronic device 104 can be a wearable device or an electronic device-mountable wearable device (such as an HMD). In those other embodiments, when the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described below, the server 106 may perform one or more functions related to fast low-light image visibility enhancement for VST XR or other applications.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

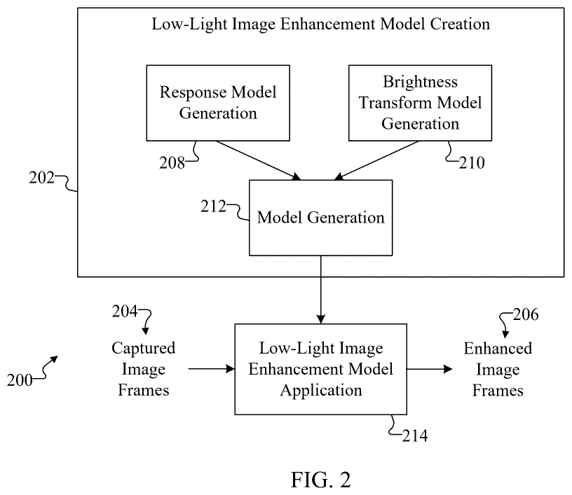

FIG. 2 illustrates an example process 200 for fast low-light image visibility enhancement for VST XR or other applications in accordance with this disclosure. For case of explanation, the process 200 shown in FIG. 2 is described as being performed using the electronic device 101 in the network configuration 100 shown in FIG. 1. However, the process 200 shown in FIG. 2 may be performed using any other suitable device(s) and in any other suitable system(s).

As shown in FIG. 2, the process 200 includes a low-light image enhancement model creation operation 202, which generally operates to create one or more low-light image enhancement models for use. Each low-light image enhancement model may represent a model that can be applied to captured image frames 204 in order to produce enhanced image frames 206. The enhanced image frames 206 can represent processed versions of the captured image frames 204 in which the brightness levels of the captured image frames 204 have been improved.

In this example, the low-light image enhancement model creation operation 202 includes a response model generation function 208 and a brightness transform model generation function 210. The response model generation function 208 generally operates to identify one or more response models for each imaging sensor 180, where each response model identifies a mathematical representation of how the imaging sensor 180 operates when capturing at least some of the image frames 204. A response model may include or represent a response function that defines a mapping of scene irradiance to image brightness or intensity based on the imaging sensor 180 used to capture the image frames 204. The response model generation function 208 can use any suitable technique(s) to identify at least one response model for each imaging sensor 180. In some cases, multiple response models may be generated for each imaging sensor 180, where different response models are associated with different scene brightnesses or different ranges of scene brightnesses.

The brightness transform model generation function 210 generally operates to identify one or more brightness models (also called lightness models) for each imaging sensor 180, where each brightness model identifies another mathematical representation of how the imaging sensor 180 operates when capturing at least some of the image frames 204. A brightness model may include or represent a brightness transform function that defines how image data captured using the imaging sensor 180 can vary based on the exposure setting of the imaging sensor 180. The brightness transform model generation function 210 can use any suitable technique(s) to identify at least one brightness model for each imaging sensor 180. In some cases, multiple brightness models may be generated for each imaging sensor 180, where different brightness models are associated with different scene brightnesses or different ranges of scene brightnesses (which can match the different scene brightnesses or different ranges of scene brightnesses during generation of multiple response models for each imaging sensor 180).

The low-light image enhancement model creation operation 202 also includes a model generation function 212, which generally operates to create one or more low-light image enhancement models based on the response model(s) and the brightness transform model(s) generated by the functions 208 and 210. For example, the model generation function 212 may combine each response model generated by the response model generation function 208 for an imaging sensor 180 and the corresponding brightness transform model generated by the brightness transform model generation function 210 for the same imaging sensor 180 in order to create a low-light image enhancement model for that imaging sensor 180. Note that this may be repeated any number of times to create multiple low-light image enhancement models for each imaging sensor 180, where different low-light image enhancement models are associated with the different scene brightnesses or the different ranges of scene brightnesses. The model generation function 212 can use any suitable technique(s) to identify at least one low-light image enhancement model for each imaging sensor 180. In some cases, for instance, the model generation function 212 may integrate each brightness transform model and an associated exposure ratio map to generate an integrated brightness transform model and combine the integrated brightness transform model and the corresponding response model. Each exposure ratio map can represent a map used for adjusting image contrast and visibility of image frames captured using an associated imaging sensor 180.

A low-light image enhancement model application operation 214 generally operates to apply the low-light image enhancement models created by the low-light image enhancement model creation operation 202 to the captured image frames 204 in order to produce the enhanced image frames 206. For example, the low-light image enhancement model application operation 214 may determine a low-light image score for each captured image frame 204, where the low-light image score is indicative of a brightness of the captured image frame 204. In response to the low-light image score indicating that the brightness of the captured image frame 204 is below a threshold, a low-light visibility enhancement model can be applied to the captured image frame 204 by the low-light image enhancement model application operation 214 in order to generate an enhanced image frame 206, which has a higher brightness than the captured image frame 204. As noted above, there may be multiple low-light visibility enhancement models for each imaging sensor 180, and the low-light image enhancement model application operation 214 may select one of the low-light visibility enhancement models for use with each captured image frame 204. For instance, the low-light visibility enhancement model can be selected based on the brightness of the captured image frame 204, such as by selecting the low-light visibility enhancement model generated using training images having the same or similar brightness. The low-light image enhancement model application operation 214 can use any suitable technique(s) to enhance image frames based on low-light visibility enhancement models. In some cases, for instance, the low-light visibility enhancement models may be used to apply brightness gains (positive or negative) at a per-pixel level to the captured image frames 204. In this way, the low-light image enhancement model application operation 214 generates the enhanced image frames 206, which represent enhanced or improved versions of the captured image frames 204.

In this way, the process 200 can be used to create one or more low-light image visibility enhancement models with one or more parametric response models and one or more parametric brightness transform models, where the parameters of each low-light image visibility enhancement model can be learned from one or more training datasets captured using an associated imaging sensor 180. The low-light image visibility enhancement model(s) can be used to remove low-light noise or other noise and improve the visibility of captured image frames 204, which may involve selecting the appropriate low-light image visibility enhancement model for each captured image frame 204. In addition, as described below, a criterion can be created (such as by combining a signal-to-noise ratio and image brightness values) and used to quickly detect if each captured image frame 204 actually needs low-light noise removal and visibility enhancement. As a result, captured image frames 204 that are adequately bright need not undergo processing using low-light image visibility enhancement models, which can reduce the computational load on the processor(s) 120 of the electronic device 101.

Although FIG. 2 illustrates one example of a process 200 for fast low-light image visibility enhancement for VST XR or other applications, various changes may be made to FIG. 2. For example, various operations or functions in FIG. 2 may be combined, further subdivided, replicated, omitted, or rearranged and additional operations or functions may be added according to particular needs.

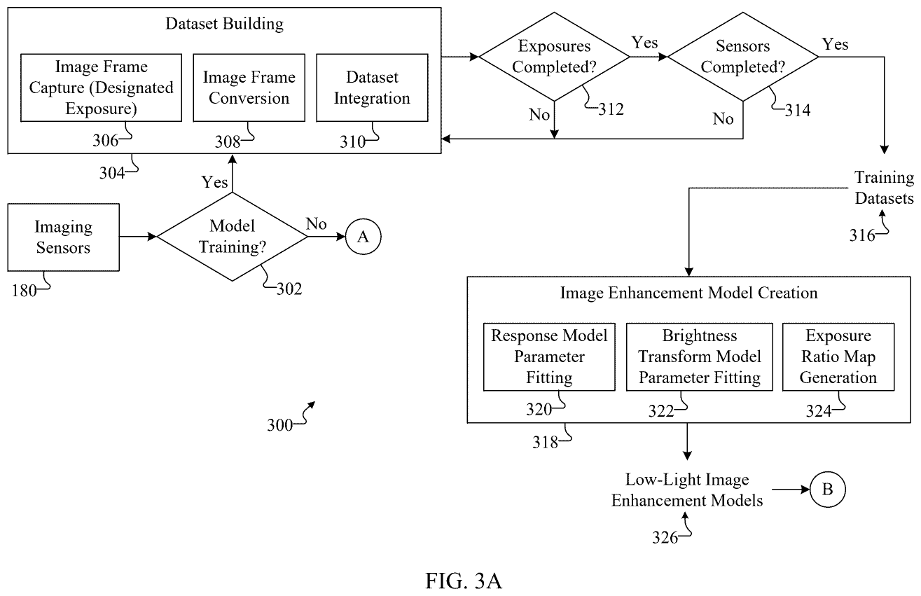

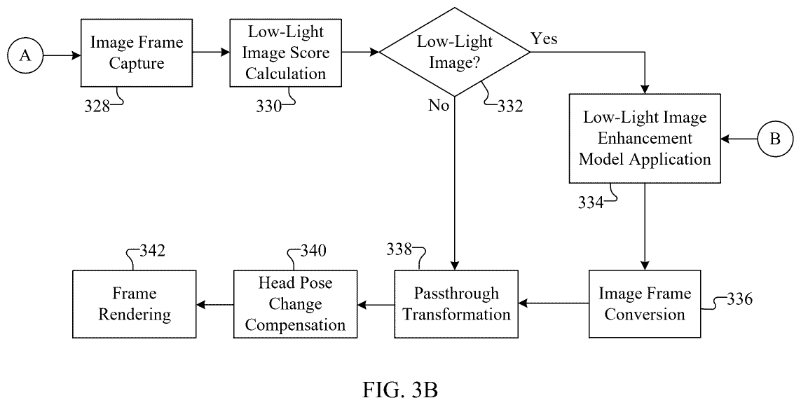

FIGS. 3A and 3B illustrate an example architecture 300 for fast low-light image visibility enhancement for VST XR or other applications in accordance with this disclosure. For ease of explanation, the architecture 300 shown in FIGS. 3A and 3B is described as being implemented using the electronic device 101 in the network configuration 100 shown in FIG. 1, where the electronic device 101 may implement the process 200 shown in FIG. 2. However, the architecture 300 may be implemented using any other suitable device(s) and in any other suitable system(s), and the architecture 300 may be used to implement any other suitable process(es) designed in accordance with this disclosure.

As shown in FIG. 3A, one or more imaging sensors 180 can be used to generate image frames. In this example, a decision operation 302 determines whether the image frames will be used for model training purposes. If so, the architecture 300 can be used to implement the low-light image enhancement model creation operation 202 described above. For example, a dataset building operation 304 generally operates to create one or more training datasets for each imaging sensor 180. Here, an image frame capture function 306 generally operates to obtain a set of image frames using a designated imaging sensor 180, where the set of image frames are captured using the same or substantially the same exposure setting(s) (such as the same exposure time). Each image frame may optionally be provided to an image frame conversion function 308, which generally operates to convert each image frame from a first image format that lacks luminance data to a second image format that includes luminance data. Any suitable image formats may be supported here. As particular examples, the image frames obtained by the image frame capture function 306 may be in RGB format, and the image frames may be converted into YUV or YCbCr format or hue, saturation, and value (HSV) format. In embodiments where the image frame conversion function 308 is used, this conversion allows for the modification of the contrast of the image frames for visibility enhancement, which may reduce computational load. A dataset integration function 310 generally operates to combine the image frames (or converted versions thereof) into a training dataset for the designated imaging sensor 180, where that training dataset is associated with the specific exposure setting(s) used to capture the image frames.

A decision operation 312 generally operates to determine if at least one training dataset has been generated for each exposure setting for which training will be performed. For example, training datasets may be produced for a number of exposure settings (such as exposure settings like EV−2, EV−1, EVO, EV+1, EV+2, etc.). If not, the dataset building operation 304 can be used to generate at least one additional training dataset for the same imaging sensor 180 but using one or more different exposure settings. Otherwise, a decision operation 314 generally operates to determine if at least one training dataset has been generated for each imaging sensor 180. If not, the dataset building operation 304 can be used to generate at least one training dataset for a different imaging sensor 180 at one or more exposure settings. This approach may be useful, for instance, to collect training datasets for left and right see-through cameras or other stereo imaging sensors 180 of a VST XR device.

This process results in the generation of one or more training datasets 316, where each training dataset 316 is associated with a specified imaging sensor 180 and a specified exposure setting. There can be multiple training datasets for each imaging sensor 180, where different training datasets are associated with different exposure settings. An image enhancement model creation operation 318 generally operates to produce one or more low-light image enhancement models using the training datasets 316. In some cases, for instance, the image enhancement model creation operation 318 may generate a low-light image enhancement model for each exposure setting of each imaging sensor 180.

In this example, the image enhancement model creation operation 318 includes a response model parameter fitting function 320, a brightness transform model parameter fitting function 322, and an exposure ratio map generation function 324. The response model parameter fitting function 320 generally operates to process each training dataset 316 and generate a corresponding response model for the associated imaging sensor 180. Again, each response model can identify a mathematical representation of how the associated imaging sensor 180 operates when capturing image frames (at least at the corresponding exposure setting). Here, the response model includes or represents a response function that defines a mapping of scene irradiance to image brightness or intensity based on the imaging sensor 180 used to capture the image frames in the training dataset 316, and the response model parameter fitting function 320 can identify parameters of the response function based on the training dataset 316. The response model parameter fitting function 320 can use any suitable curve-fitting technique or other technique to identify parameters of response models.

Similarly, the brightness transform model parameter fitting function 322 generally operates to process each training dataset 316 and generate a corresponding brightness transform model for the associated imaging sensor 180. Again, each brightness transform model can identify another mathematical representation of how the imaging sensor 180 operates when capturing image frames (at least at the corresponding exposure setting). Here, the brightness transform model includes or represents a brightness transform function that defines how image data captured using the imaging sensor 180 can vary based on the exposure setting of the imaging sensor 180, and the brightness transform model parameter fitting function 322 can identify parameters of the brightness transform function based on the training dataset 316. The brightness transform model parameter fitting function 322 can use any suitable curve-fitting technique or other technique to identify parameters of brightness transform models.

The exposure ratio map generation function 324 generally operates to identify an exposure ratio map for each imaging sensor 180. Each exposure ratio map can represent a mapping that identifies an exposure ratio at each pixel of the image frames captured by the associated imaging sensor 180. As described below, each brightness transform model can be a function of the associated exposure ratio map, and identifying the actual exposure ratio map for each imaging sensor 180 allows each brightness transform model to be integrated with its associated exposure ratio map during creation of low-light image enhancement models. The exposure ratio map generation function 324 can use any suitable technique to identify exposure ratio maps for imaging sensors 180. The image enhancement model creation operation 318 uses the response models, brightness transform models, and exposure ratio maps to create low-light image enhancement models 326. For instance, the image enhancement model creation operation 318 may generate a low-light image enhancement model 326 for each exposure setting of each imaging sensor 180.

As shown in FIG. 3B, when the decision operation 302 determines that the image frames captured using the imaging sensors 180 are not used for model training purposes, an image capture operation 328 generally operates to obtain image frames from the one or more imaging sensors 180. A low-light image score calculation operation 330 generally operates to identify a low-light image score for each captured image frame, where the low-light image score is indicative of a brightness of the associated image frame. The low-light image score can be determined in any suitable manner, such as when the low-light image score is based on the signal-to-noise ratio and average brightness of the associated image frame. A decision operation 332 generally operates to determine if each image frame represents a low-light image frame, such as by comparing the low-light image score for each image frame to a specified threshold. For each image frame that is a low-light image frame (such as when its low-light image score is below the threshold), the image frame can be provided to a low-light image enhancement model application operation 334, which may represent or implement the low-light image enhancement model application operation 214 described above. For each image frame that is not a low-light image frame, the image frame can be provided to a passthrough transformation operation 338.

The low-light image enhancement model application operation 334 can apply the low-light image enhancement models 326 generated by the image enhancement model creation operation 318 to the low-light image frames, thereby generating enhanced image frames. For example, for each low-light image frame, the low-light image enhancement model application operation 334 can select one of multiple low-light image enhancement models (such as based on the imaging sensor 180 that captured the low-light image frame and the overall brightness of the low-light image frame) and apply the selected low-light image enhancement model to the low-light image frame. Gains in the selected low-light image enhancement model can be applied to the pixels of the low-light image frame so that the resulting enhanced image frame has a higher brightness than the low-light image frame.

In some cases, the low-light image enhancement model application operation 334 includes a conversion of the low-light image frame from a first image format that lacks luminance data to a second image format that includes luminance data. In those embodiments, an image frame conversion function 336 may optionally be used to convert each enhanced image frame from the second image format back to the first image format or to a third image format. Any suitable image formats may be supported here. As particular examples, the enhanced image frames generated by the low-light image enhancement model application operation 334 may be in YUV, YCbCr, or HSV format, and the enhanced image frames may be converted into RGB format.

Non-low-light image frames and enhanced image frames are provided to the passthrough transformation operation 338, which generally operates to apply one or more transformations to the image frames in order to generate transformed image frames. For example, the passthrough transformation operation 338 may apply transformations to compensate for things like registration and parallax errors, which may be caused by factors like differences between the positions of the imaging sensor(s) 180 and a user's eyes. That is, captured image frames are captured by one or more imaging sensor(s) 180 at one or more locations, but rendered images are viewed by a user's eyes that are at different locations. The passthrough transformation operation 338 can apply one or more transformations in order to compensate for these differences in viewpoints. In some cases, the passthrough transformation operation 338 may apply a rotation and/or a translation to each image frame in order to compensate for these or other types of issues. Ideally, the transformations give the appearance that the images presented to the user are captured at the locations of the user's eyes, when the image frames in reality are captured at one or more different locations. Often times, the rotation and/or translation can be derived mathematically based on the position and angle of each imaging sensor 180 and the expected or actual positions of the user's eyes. In some cases, the transformations are static (since these positions and angles will not change), allowing passthrough transformations to be applied quickly.

A head pose change compensation operation 340 generally operates to apply an additional transformation to reproject each of the transformed image frames generated by the passthrough transformation operation 338 based on a head pose change of the user (if necessary). For example, the head pose change compensation operation 340 may obtain inputs from an IMU, a head pose tracking camera, or other position sensor(s) 180 of the electronic device 101 while image frames are being captured using the one or more imaging sensors 180. The head pose change compensation operation 340 can use this information to estimate what the user's head pose will likely be when rendered images are actually displayed to the user. In many cases, for instance, image frames will be captured at one time and rendered images will be subsequently displayed to the user some amount of time later, and it is possible for the user to move his or her head during this intervening time period. The head pose change compensation operation 340 can therefore be used to estimate, for each image frame, what the user's head pose will likely be when a rendered image based on that image frame will be displayed to the user. The head pose change compensation operation 340 can also apply a translation, rotation, and/or other transformation to each transformed image frame, which can result in the generation of additional transformed image frames.

A frame rendering operation 342 generally operates to create final views of a scene captured in the transformed image frames. The frame rendering operation 342 can also render the final views for presentation to a user of the electronic device 101. For example, the frame rendering operation 342 may process the transformed image frames and perform any additional refinements or modifications needed or desired, and the resulting images can represent the final views of the scene. For instance, a 3D-to-2D warping can be used to warp the final views of the scene into 2D images. The frame rendering operation 342 can also present the rendered images to the user. For example, the frame rendering operation 342 can render the images into a form suitable for transmission to at least one display 160 and can initiate display of the rendered images, such as by providing the rendered images to one or more displays 160. In some cases, there may be a single display 160 on which the rendered images are presented for viewing by the user, such as where each eye of the user views a different portion of the display 160. In other cases, there may be separate displays 160 on which the rendered images are presented for viewing by the user, such as one display 160 for each of the user's eyes.

Although FIGS. 3A and 3B illustrate one example of an architecture 300 for fast low-light image visibility enhancement for VST XR or other applications, various changes may be made to FIGS. 3A and 3B. For example, various components, operations, or functions in FIGS. 3A and 3B may be combined, further subdivided, replicated, omitted, or rearranged and additional components, operations, or functions may be added according to particular needs. Also, this example assumes that response and brightness transform models are used to generate low-light image enhancement models 326, where parameters of the response and brightness transform models are identified using curve fitting. However, other techniques for generating low-light image enhancement models may be used, such as when one or more machine learning models are used to process the training datasets 316 and identify parameters of the low-light image enhancement models 326. In addition, while certain image formats (such as RGB, YUV, YCbCr, and HSV formats) are described above, other image formats may be used. For instance, each low-light RGB image frame may be converted into a L-a-b image format, where the L (lightness) component undergoes contrast improvement to enhance the visibility of the low-light image frame (possibly followed by conversion back to the RGB image format or another image format).

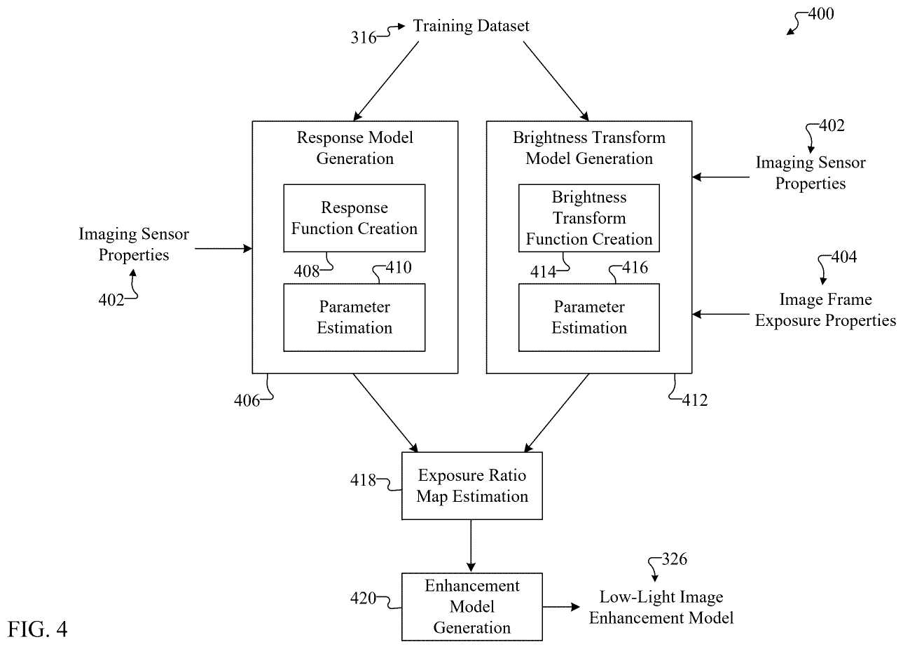

FIG. 4 illustrates an example technique 400 for creating a low-light image enhancement model 326 in accordance with this disclosure. The technique 400 may, for example, be performed as part of the low-light image enhancement model creation operation 202 of FIG. 2 or as part of the image enhancement model creation operation 318 of FIG. 3A. For ease of explanation, the technique 400 shown in FIG. 4 is described as being performed using the electronic device 101 in the network configuration 100 shown in FIG. 1, where the electronic device 101 may implement the process 200 shown in FIG. 2 and/or the architecture 300 shown in FIGS. 3A and 3B. However, the technique 400 may be performed using any other suitable device(s) and in any other suitable system(s), and the technique 400 may be used to implement any other suitable process(es) or architecture(s).

As shown in FIG. 4, the technique 400 involves the use of at least one training dataset 316, along with one or more imaging sensor properties 402 and one or more image frame exposure properties 404. In some cases, the image frames of the training dataset 316 may have been converted into an image format that includes luminance data, such as YUV, YCbCr, HSV, or L-a-b format. The one or more imaging sensor properties 402 are associated with the imaging sensor 180 used to capture the image frames in the training dataset 316, such as one or more intrinsic parameters of the associated imaging sensor 180. Intrinsic parameters can include focal distance (focal length) and coordinates of the center of the imaging sensor 180 in a camera coordinate system. The one or more image frame exposure properties 404 are associated with the exposure setting of the imaging sensor 180 used to capture the image frames in the training dataset 316, such as an exposure time.

A response model generation operation 406 generally operates to process at least some of these inputs in order to generate a response model for the imaging sensor 180 at the exposure setting associated with the training dataset 316. For example, a response function creation operation 408 may be used to generate a response function for the imaging sensor 180, and a parameter estimation operation 410 may be used to generate parameters of the response function (such as via curve fitting). Similarly, a brightness transform model generation operation 412 generally operates to process at least some of these inputs in order to generate a brightness transform model for the imaging sensor 180 at the exposure setting associated with the training dataset 316. For instance, a brightness transform function creation operation 414 may be used to generate a brightness transform function for the imaging sensor 180, and a parameter estimation operation 416 may be used to generate parameters of the brightness transform function (such as via curve fitting).

An exposure ratio map estimation operation 418 generally operates to process the response and brightness transform functions in order to generate an exposure ratio map for the imaging sensor 180. The exposure ratio map can represent a map used for adjusting image contrast and visibility of image frames captured using the imaging sensor 180. The exposure ratio map and the response and brightness transform functions can be used by an enhancement model generation operation 420, which can generate a low-light image enhancement model 326 based on the training dataset 316.

In some embodiments, the creation of a low-light image enhancement model 326 may occur as follows. The response function creation operation 408 may generate a response function based on the following.

$$P ( x , y ) = R ( E ( x , y ) )$$

Here, P(x, y) represents a pixel value at coordinates (x, y), E(x, y) represents image irradiance at coordinates (x, y), and R(⋅) represents a nonlinear response function. The parameter estimation operation 410 estimates the parameters of the function R(⋅) using one or more training datasets 316 generated using the imaging sensor 180 at one or more exposure settings.

In some cases, the response function R(⋅) may be defined as having the following form.

$$ℛ ( E ( x ) ) = ( 1 + α ) \frac{{E ( x )}^{β}}{{E ( x )}^{β} + α}$$

Here, E(x) represents image irradiance, and (α, β) represent camera parameters (which in some embodiments could be obtained during manufacture calibration or other calibration).

The brightness transform function creation operation 414 may generate a brightness transform function based on the following.

$${I}_{{p}_{i}} ( x , y ) = T ( {I}_{{p}_{j}} ( x , y ) , K ( x , y ) )$$

Here, Iₚ_{ᵢ}(x, y) represents a pixel value at exposure pᵢ, Iₚ_{ⱼ} represents a pixel value at exposure pⱼ, K(x, y) represents an exposure ratio map, and T(⋅) represents a brightness transform function. The parameter estimation operation 416 estimates the parameters of the function T(⋅) using one or more training datasets 316 generated using the imaging sensor 180 at one or more exposure settings. In some cases, the brightness transform function T(⋅) may be defined as having the following form.

$$T ( I ( x ) , K ( x ) ) = \frac{{K ( x )}^{β} I ( x ) ( 1 + α )}{( {K ( x )}^{β} - 1 ) I ( x ) + 1 + α}$$

Here, I(x) represents an original image frame, and (α, β) represent imaging sensor parameters.

Using the generated response model and brightness transform model, the exposure ratio map estimation operation 418 estimates the exposure map K(x, y), which can define an exposure ratio at each pixel of an image to be enhancement. The enhancement model generation operation 420 can integrate the brightness transform model with the estimated exposure ratio map since the brightness transform function T(⋅) is a function of the estimated exposure ratio map, thereby generating an integrated brightness transform model. The low-light image enhancement models 326 may be generated using a combination of the integrated brightness transform model and the response model.

Although FIG. 4 illustrates one example of a technique 400 for creating a low-light image enhancement model 326, various changes may be made to FIG. 4. For example, a low-light image enhancement model 326 may be generated in any other suitable manner, such as by using one or more trained machine learning models.

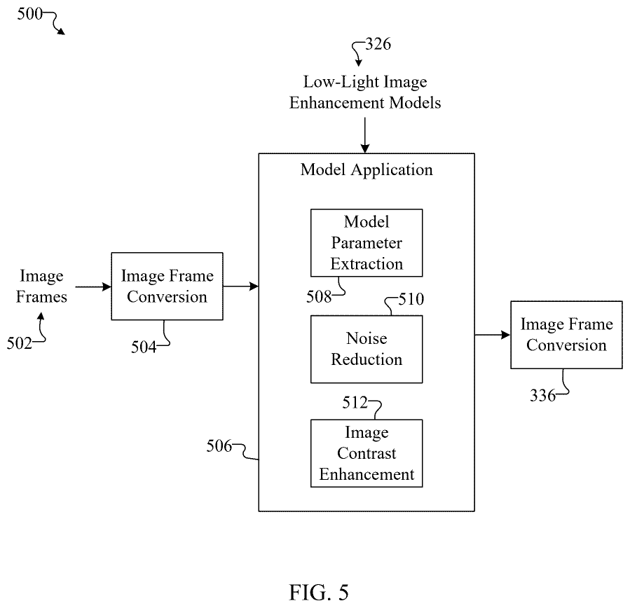

FIG. 5 illustrates an example technique 500 for applying adaptive low-light visibility enhancement in accordance with this disclosure. The technique 500 may, for example, be performed as part of the low-light image enhancement model application operation 214 of FIG. 2 or as part of the low-light image enhancement model application operation 334 of FIG. 3B. For case of explanation, the technique 500 shown in FIG. 5 is described as being performed using the electronic device 101 in the network configuration 100 shown in FIG. 1, where the electronic device 101 may implement the process 200 shown in FIG. 2 and/or the architecture 300 shown in FIGS. 3A and 3B. However, the technique 500 may be performed using any other suitable device(s) and in any other suitable system(s), and the technique 500 may be used to implement any other suitable process(es) or architecture(s).

As shown in FIG. 5, the technique 500 involves the processing of image frames 502, which may be captured using one or more imaging sensors 180 and the image capture operation 328. The image frames 502 may optionally be provided to an image conversion operation 504, which can convert the image frames 502 from a first image format that lacks luminance data (such as RGB format) to a second image format that includes luminance data (such as YUV, YCbCr, HSV, or L-a-b format). The luminance channel of each image frame 502 may be processed subsequently to provide image enhancement, with or without modifications to other color channels of each image frame 502.

In this example, the low-light image enhancement models 326 (which are created using response models and brightness transform models based on training datasets as described above) are provided to a model application operation 506, which generally operates to apply a selected low-light image enhancement model 326 to each image frame 502. In this example, the model application operation 506 includes a model parameter extraction function 508, which generally operates to identify the parameters of the selected low-light image enhancement model 326 to be applied to each image frame 502.

A noise reduction function 510 generally operates to perform noise reduction in order to at least partially remove noise from each image frame 502. For example, the noise reduction function 510 may perform filtering or other suitable noise removal technique(s) in order to remove noise and replace the noise with suitable image data. In some embodiments, the noise reduction function 510 can use the parameters of the low-light image enhancement model 326 selected for each image frame 502 when performing noise reduction. An image contrast enhancement function 512 generally operates to perform adaptive image contrast enhancement for each image frame 502 based on the parameters of the low-light image enhancement model 326 selected for use with that image frame 502. For example, the image contrast enhancement function 512 may use the parameters of the selected low-light image enhancement model 326 to identify gains to be applied to at least the luminance data of the associated image frame 502. For each image frame 502, the model application operation 506 generates an enhanced image frame, which may optionally be provided to the image frame conversion function 336 for conversion.

Although FIG. 5 illustrates one example of a technique 500 for applying adaptive low-light visibility enhancement, various changes may be made to FIG. 5. For example, a low-light image enhancement model 326 may be applied in any other suitable manner.

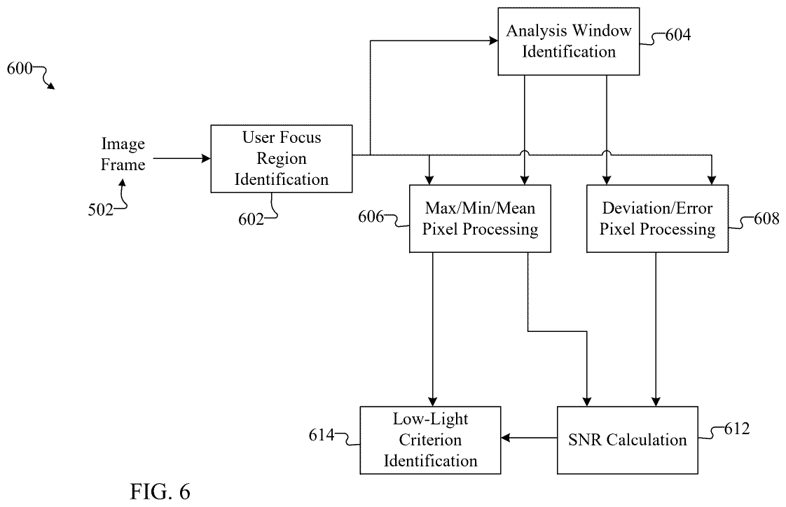

FIG. 6 illustrates an example technique 600 for performing adaptive low-light image frame detection in accordance with this disclosure. The technique 600 may, for example, be performed as part of the low-light image score calculation operation 330 and the decision operation 332 of FIG. 3B to determine if an image frame represents a low-light image frame. For case of explanation, the technique 600 shown in FIG. 6 is described as being performed using the electronic device 101 in the network configuration 100 shown in FIG. 1, where the electronic device 101 may implement the process 200 shown in FIG. 2 and/or the architecture 300 shown in FIGS. 3A and 3B. However, the technique 600 may be performed using any other suitable device(s) and in any other suitable system(s), and the technique 600 may be used to implement any other suitable process(es) or architecture(s).

As shown in FIG. 6, each image frame 502 may be provided to a user focus region identification operation 602, which generally operates to identify an area of the image frame 502 associated with a region of a scene at which the user appears to be gazing or on which the user appears to be focusing (if any). This may be done in any suitable manner, such as by using one or more eye tracking and gaze estimation techniques, such as one based on gaze direction estimation and focal length estimation. An analysis window identification operation 604 identifies a window within the image frame 502 to be analyzed, where image contents within the window are used to determine if the image frame 502 represents a low-light image frame. For instance, the analysis window identification operation 604 may define a window within each image frame 502 that matches or includes the focus region identified within that image frame 502 by the user focus region identification operation 602.

A max/min/mean pixel processing operation 606 generally operates to identify the largest (maximum) and smallest (minimum) pixel values within the analysis window and the average (mean) pixel value within the analysis window for each image frame 502. In some cases, the minimum pixel value Pₘᵢₙ, the maximum pixel value Pₘₐₓ, and the average pixel value Pₘₑₐₙ may be expressed as follows.

$$\{ \begin{matrix}{P}_{min} = {min}_{( x , y ) ∈ w} I ( x , y ) \\ {P}_{max} = {max}_{( x , y ) ∈ w} I ( x , y ) \\ {P}_{m e a n} = {mean}_{( x , y ) ∈ w} I ( x , y )\end{matrix}$$

Here, l(x, y) represents an image frame 502, w represents an analysis window within the image frame 502, and p(x, y)∈w represents each pixel in the analysis window w. A deviation/error pixel processing operation generally operates to identify the standard deviation of the pixel values within the analysis window for each image frame 502. In some cases, the standard deviation may be determined as follows.

$$\{ \begin{matrix}μ = \frac{1}{N} {\sum }_{i = 1}^{N} I ( {p}_{i} ( x , y ) ) \\ {σ}^{2} = \frac{1}{N} {\sum }_{i = 1}^{N} I ( {{p}_{i} ( x , y )}^{2} - {μ}^{2} )\end{matrix}$$

Here, N represents the number of the pixels in the analysis window w, μ represents the mean pixel value in the analysis window w, σ represents the standard deviation of the pixel values in the analysis window w, and pᵢ(x, y)∈w represents each pixel in the analysis window w.

A pixel signal P_{signal} may be defined as equaling Pₘₑₐₙ, and a noise signal Pₙₒᵢₛₑ may be defined as equaling σ. An SRN calculation operation 612 generally operates to calculate the SNR of each image frame 502 (or the SNR of the analysis window within each image frame 502) using these pixel and noise signals. For example, the SRN calculation operation 612 may calculate the SNR of each image frame 502 as follows.

$$S N R = 10 {log}_{10}^{( \frac{{P}_{s i g n a l}}{{P}_{n o i s e}} )}$$

A low-light criterion identification operation 614 generally operates to create a criterion for determining whether each image frame 502 represents a low-light image frame. In some embodiments, the criterion is based on the average pixel value Pₘₑₐₙ and the SNR value SNR. As a particular example, the low-light criterion identification operation 614 may use the following criterion to determine whether each image frame 502 represents a low-light image frame.

$$C = \{ \begin{matrix}{P}_{mean} < P and SNR < S if I ( x , y ) is a low - light image \\ Other\end{matrix}$$

Here, P represents a threshold of the low-light image value for the image frame 502, and S represents a threshold of the signal-to-noise ratio for the image frame 502. In this example, a low-light image score can be defined as the average pixel value Pₘₑₐₙ, optionally in combination with the SNR value SNR.

Although FIG. 6 illustrates one example of a technique 600 for performing adaptive low-light image frame detection, various changes may be made to FIG. 6. For example, any other suitable low-light criterion based on any other suitable low-light score (which may or may not include average image brightness and/or SNR) may be used.

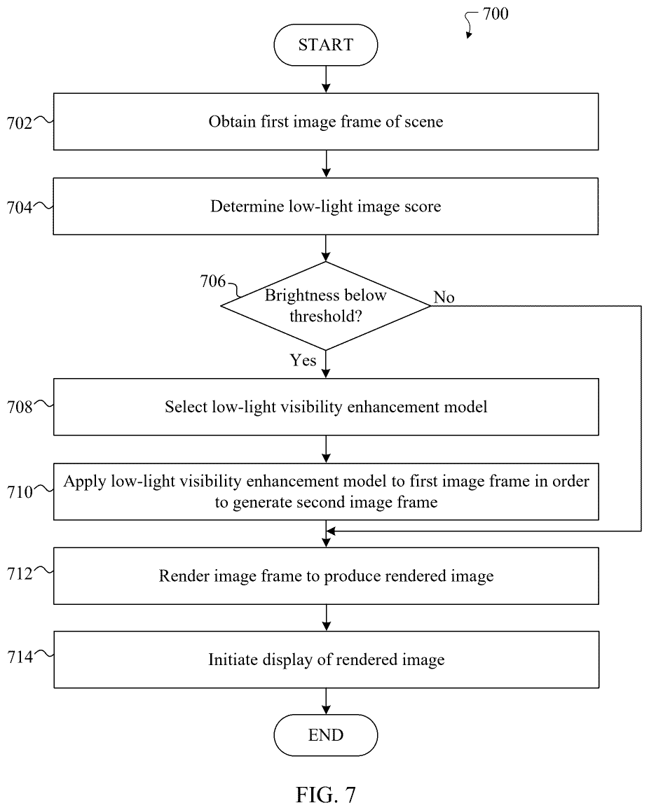

FIG. 7 illustrates an example method 700 for fast low-light image visibility enhancement for VST XR or other applications in accordance with this disclosure. For case of explanation, the method 700 shown in FIG. 7 is described as being performed using the electronic device 101 in the network configuration 100 shown in FIG. 1, where the electronic device 101 may implement the process 200 shown in FIG. 2 and/or the architecture 300 shown in FIGS. 3A and 3B. However, the method 700 may be performed using any other suitable device(s) and in any other suitable system(s), and the method 700 may be implemented using any other suitable process(es) or architecture(s) designed in accordance with this disclosure.

As shown in FIG. 7, a first image frame of a scene is obtained at step 702. This may include, for example, the processor 120 of the electronic device 101 obtaining an image frame 502 captured using at least one imaging sensor 180 of the electronic device 101. A low-light image score indicative of a brightness of the first image frame is determined at step 704. This may include, for example, the processor 120 of the electronic device 101 calculating an average pixel value and SNR value for at least a portion of the image frame 502, such as for pixel values within an analysis window of the image frame 502. The analysis window can include or be defined as a portion of the first image frame representing an area in the scene on which a user's eyes are gazing or focused. A determination is made whether the brightness represented by the low-light image score is below a specified threshold at step 706. This may include, for example, the processor 120 of the electronic device 101 comparing the average pixel value and/or the SNR value to one or more threshold values.

If the brightness represented by the low-light image score is below the specified threshold, this is indicative that the image frame 502 represents a low-light image frame. In this case, a low-light visibility enhancement model is selected at step 708. This may include, for example, the processor 120 of the electronic device 101 selecting the low-light image enhancement model 326 that is (i) associated with the imaging sensor(s) 180 used to capture the image frame 502 and (ii) associated with the same or similar average or overall brightness as the image frame 502. The selected low-light visibility enhancement model is applied to the first image frame in order to generate a second image frame at step 710. This may include, for example, the processor 120 of the electronic device 101 applying gains defined by the selected low-light image enhancement model 326 to luminance data of the image frame 502 in order to perform contrast enhancement and generate an enhanced image frame. The enhanced image frame has a higher brightness than the original image frame 502. In some cases, the first image frame may be converted from a first image format that lacks luminance data to a second image format that includes luminance data prior to application of the low-light image enhancement model 326, and the second image frame may be converted from the second image format to the first image format or a third image format after application of the low-light image enhancement model 326. If the brightness represented by the low-light image score is above the specified threshold, this is indicative that the image frame 502 does not represent a low-light image frame. In that case, the processor 120 of the electronic device 101 can refrain from applying a low-light image enhancement model 326 to the first image frame.

An image frame (either the first image frame if low-light visibility enhancement is not applied or the second image frame if low-light visibility enhancement is applied) is rendered at step 712, and display of the rendered image is initiated at step 714. This may include, for example, the processor 120 of the electronic device 101 applying a passthrough transformation, head pose change compensation transformation, and/or other transformation(s) to the image frame. This may also include the processor 120 of the electronic device 101 rendering the resulting transformed image frame and displaying the rendered image on at least one display 160 of the electronic device 101.

Although FIG. 7 illustrates one example of a method 700 for fast low-light image visibility enhancement for VST XR or other applications, various changes may be made to FIG. 7. For example, while shown as a series of steps, various steps in FIG. 7 may overlap, occur in parallel, occur in a different order, or occur any number of times (including zero times). Also, the method 700 may be duplicated or repeatedly used in order to process multiple image frames, such as sequences of image frames from left and right see-through cameras or other sets of imaging sensors 180.

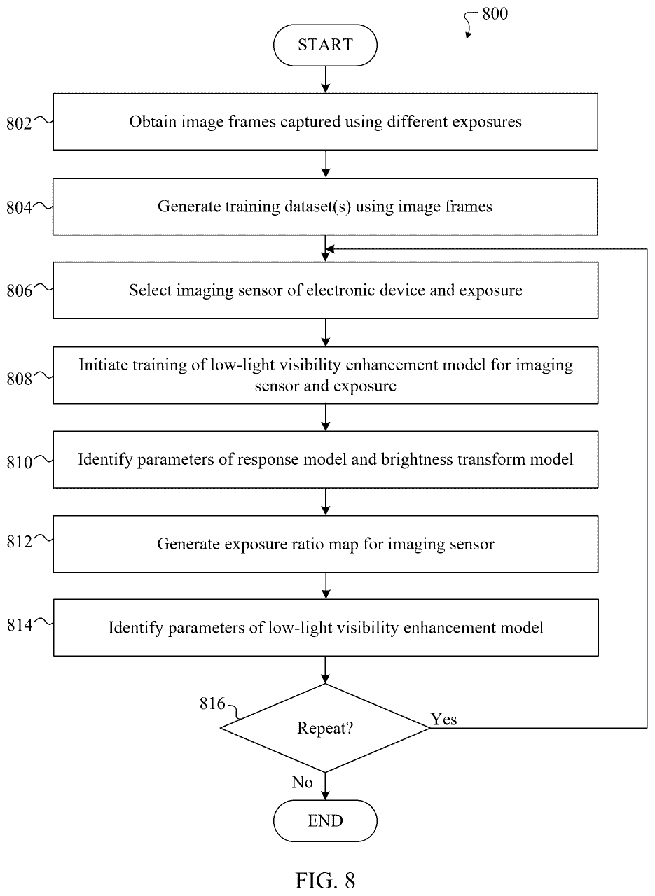

FIG. 8 illustrates an example method 800 for training a low-light visibility enhancement model in accordance with this disclosure. For case of explanation, the method 800 shown in FIG. 8 is described as being performed using the electronic device 101 in the network configuration 100 shown in FIG. 1, where the electronic device 101 may implement the process 200 shown in FIG. 2 and/or the architecture 300 shown in FIGS. 3A and 3B. However, the method 800 may be performed using any other suitable device(s) and in any other suitable system(s), and the method 800 may be implemented using any other suitable process(es) or architecture(s) designed in accordance with this disclosure.

As shown in FIG. 8, image frames captured using different exposures are obtained at step 802. This may include, for example, the processor 120 of the electronic device 101 obtaining multiple image frames captured using each of one or more imaging sensors 180 of the electronic device 101. The multiple image frames for each imaging sensor 180 are captured using different exposures, such as different exposure times or other exposure settings. One or more training datasets are generated using the image frames at step 804. This may include, for example, the processor 120 of the electronic device 101 creating a training dataset 316 for each exposure setting of each imaging sensor 180.

An imaging sensor and an exposure are selected at step 806. This may include, for example, the processor 120 of the electronic device 101 selecting a specified imaging sensor 180 and selecting one of the exposure settings for that imaging sensor 180 used to capture image frames in at least one of the training datasets 316. Training of a low-light visibility enhancement model for the selected imaging sensor and the selected exposure is initiated at step 808. This may include, for example, the processor 120 of the electronic device 101 invoking the image enhancement model creation operation 318 for the selected imaging sensor 180 and the selected exposure using the training dataset(s) 316 associated with the selected imaging sensor 180 and the selected exposure.

During the training, parameters of a response model and a brightness transform model are identified at step 810. This may include, for example, the processor 120 of the electronic device 101 identifying parameters for a response model associated with the selected imaging sensor 180 based on the images in the associated training dataset(s) 316 and one or more imaging sensor properties 402 for the selected imaging sensor 180. This may also include the processor 120 of the electronic device 101 identifying parameters for a brightness transform model associated with the selected imaging sensor 180 based on the images in the associated training dataset(s) 316, the one or more imaging sensor properties 402 for the selected imaging sensor 180, and one or more image frame exposure properties 404. Thus, the parameters of the response model and the brightness transform model are based on at least part of the training dataset(s) 316. An exposure ratio map for adjusting image contrast and visibility is generated at step 812. This may include, for example, the processor 120 of the electronic device 101 generating an exposure ratio map K(x, y) as described above. Parameters of a low-light visibility enhancement model are identified at step 814. This may include, for example, the processor 120 of the electronic device 101 generating the low-light image enhancement model 326 based on the response model, the brightness transform model, and the exposure ratio map. For instance, the exposure ratio map may be integrated with the brightness transform model to generate an integrated brightness transform model, and the integrated brightness transform model and the response model may be combined to generate the low-light image enhancement model 326. In some cases, the image frames in the training dataset(s) 316 may be converted from a first image format that lacks luminance data to a second image format that includes luminance data prior to use in generating the low-light image enhancement model 326.

A determination is made whether to repeat the training and generate another low-light visibility enhancement model at step 816. This may include, for example, the processor 120 of the electronic device 101 determining whether a low-light image enhancement model 326 has been generated for each exposure setting of each imaging sensor 180. If not, the process can return to step 806 to select another imaging sensor/exposure setting combination. Depending on the situation, this may involve selecting another exposure setting for the same imaging sensor 180 selected in the prior iteration, or this may involve selecting an exposure setting for another imaging sensor 180.

Although FIG. 8 illustrates one example of a method 800 for training a low-light image enhancement model 326, various changes may be made to FIG. 8. For example, while shown as a series of steps, various steps in FIG. 8 may overlap, occur in parallel, occur in a different order, or occur any number of times (including zero times).

It should be noted that the functions shown in or described with respect to FIGS. 2 through 8 can be implemented in an electronic device 101, 102, 104, server 106, or other device(s) in any suitable manner. For example, in some embodiments, at least some of the functions shown in or described with respect to FIGS. 2 through 8 can be implemented or supported using one or more software applications or other software instructions that are executed by the processor 120 of the electronic device 101, 102, 104, server 106, or other device(s). In other embodiments, at least some of the functions shown in or described with respect to FIGS. 2 through 8 can be implemented or supported using dedicated hardware components. In general, the functions shown in or described with respect to FIGS. 2 through 8 can be performed using any suitable hardware or any suitable combination of hardware and software/firmware instructions. Also, the functions shown in or described with respect to FIGS. 2 through 8 can be performed by a single device or by multiple devices.

Although this disclosure has been described with example embodiments, various changes and modifications may be suggested to one skilled in the art. It is intended that this disclosure encompass such changes and modifications as fall within the scope of the appended claims.

What is claimed is:

1. A method comprising:
obtaining, using at least one imaging sensor of an electronic device, a first image frame of a scene;
determining, using at least one processing device of the electronic device, a low-light image score indicative of a brightness of the first image frame; and
in response to the low-light image score indicating that the brightness of the first image frame is below a threshold, applying, using the at least one processing device, a low-light visibility enhancement model to the first image frame in order to generate a second image frame having a higher brightness than the first image frame;
wherein the low-light visibility enhancement model is trained using at least one dataset that includes image frames obtained using the at least one imaging sensor of the electronic device.

2. The method of claim 1, wherein:
the low-light visibility enhancement model comprises a specified one of multiple low-light visibility enhancement models; and
the method further comprises selecting the specified low-light visibility enhancement model from among the multiple low-light visibility enhancement models based on the brightness of the first image frame.

3. The method of claim 1, further comprising:
in response to the low-light image score indicating that the brightness of the first image frame is above the threshold, refraining from applying the low-light visibility enhancement model to the first image frame.

4. The method of claim 1, further comprising:
training the low-light visibility enhancement model using the at least one dataset;
wherein training the low-light visibility enhancement model comprises, for each of the at least one imaging sensor:
identifying parameters of a response model and a brightness transform model based on at least part of the at least one dataset;
generating an exposure ratio map for adjusting image contrast and visibility;
integrating the brightness transform model and the exposure ratio map to generate an integrated brightness transform model; and
combining the integrated brightness transform model and the response model.

5. The method of claim 1, wherein the low-light image score comprises a signal-to-noise ratio (SNR) and an image brightness value associated with the first image frame.

6. The method of claim 1, wherein the low-light image score is based on image data in a portion of the first image frame, the portion of the first image frame representing an area in the scene on which a user's eyes are gazing or focused.

7. The method of claim 1, further comprising:
prior to application of the low-light visibility enhancement model, converting the first image frame from a first image format that lacks luminance data to a second image format that includes luminance data; and
after application of the low-light visibility enhancement model to at least some of the luminance data, converting the second image frame from the second image format to the first image format or a third image format.

8. The method of claim 1, further comprising:
applying at least one transformation to the second image frame in order to generate a transformed image frame; and
rendering the transformed image frame for display.

9. An apparatus comprising:
at least one imaging sensor; and
at least one processing device configured to:
obtain a first image frame of a scene captured using the at least one imaging sensor;
determine a low-light image score indicative of a brightness of the first image frame; and
in response to the low-light image score indicating that the brightness of the first image frame is below a threshold, apply a low-light visibility enhancement model to the first image frame in order to generate a second image frame having a higher brightness than the first image frame;
wherein the low-light visibility enhancement model is trained using at least one dataset that includes image frames obtained using the at least one imaging sensor.

10. The apparatus of claim 9, wherein:
the low-light visibility enhancement model comprises a specified one of multiple low-light visibility enhancement models; and
the at least one processing device is further configured to select the specified low-light visibility enhancement model from among the multiple low-light visibility enhancement models based on the brightness of the first image frame.

11. The apparatus of claim 9, wherein the at least one processing device is further configured, in response to the low-light image score indicating that the brightness of the first image frame is above the threshold, to refrain from applying the low-light visibility enhancement model to the first image frame.

12. The apparatus of claim 9, wherein:
the at least one processing device is further configured to train the low-light visibility enhancement model using the at least one dataset; and
to train the low-light visibility enhancement model, the at least one processing device is configured, for each of the at least one imaging sensor, to:
identify parameters of a response model and a brightness transform model based on at least part of the at least one dataset;
generate an exposure ratio map for adjusting image contrast and visibility;
integrate the brightness transform model and the exposure ratio map to generate an integrated brightness transform model; and
combine the integrated brightness transform model and the response model.

13. The apparatus of claim 9, wherein the low-light image score comprises a signal-to-noise ratio (SNR) and an image brightness value associated with the first image frame.

14. The apparatus of claim 9, wherein the low-light image score is based on image data in a portion of the first image frame, the portion of the first image frame representing an area in the scene on which a user's eyes are gazing or focused.

15. The apparatus of claim 9, wherein the at least one processing device is further configured to:
prior to application of the low-light visibility enhancement model, convert the first image frame from a first image format that lacks luminance data to a second image format that includes luminance data; and
after application of the low-light visibility enhancement model to at least some of the luminance data, convert the second image frame from the second image format to the first image format or a third image format.

16. A method comprising:
obtaining, using at least one imaging sensor of an electronic device, image frames having different exposures;
generating, using at least one processing device of the electronic device, at least one training dataset using the image frames; and
training at least one low-light visibility enhancement model using the at least one dataset, each low-light visibility enhancement model trained to increase brightness in captured image frames;
wherein training the at least one low-light visibility enhancement model comprises, for each of the at least one imaging sensor:
identifying parameters of a response model and a brightness transform model based on at least part of the at least one dataset; and
generating an exposure ratio map for adjusting image contrast and visibility, the low-light visibility enhancement model based on the response model, the brightness transform model, and the exposure ratio map.

17. The method of claim 16, wherein:
the at least one imaging sensor comprises multiple imaging sensors; and
multiple exposure ratio maps are generated, each exposure ratio map for adjusting image contrast and visibility of image frames captured using an associated one of the imaging sensors.

18. The method of claim 16, wherein, for each of the at least one imaging sensor:
the parameters of the response model are based on one or more properties of the imaging sensor; and
the parameters of the brightness transform model are based on the one or more properties of the imaging sensor and one or more exposure properties of the image frames captured using the imaging sensor.

19. The method of claim 16, wherein, for each of the at least one imaging sensor, the exposure ratio map is integrated with the brightness transform model to generate an integrated brightness transform model, and the integrated brightness transform model and the response model are combined to generate the low-light visibility enhancement model for the imaging sensor.

20. The method of claim 16, further comprising:
converting the image frames from a first image format that lacks luminance data to a second image format that includes luminance data;
wherein, for each of the at least one imaging sensor, the parameters of at least one of the response model or the brightness transform model are identified using the luminance data of the image frames captured using the imaging sensor.
